(19) United States
(12) Patent Application Publication
(10) Pub. No.: US 2002/0186208 A1
(43) Pub. Date: Dec. 12, 2002

(54) Organic electroluminescent display with integrated touch screen

(75) Inventors: Rodney D. Feldman, Rochester, NY (US); Andre D. Cropper, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/855,449

(22) Filed: May 15, 2001

(51) Int. Cl. G09G 5/00; G09G 3/30

(52) U.S. Cl. 345/173; 345/76

(57) ABSTRACT

An electroluminescent display with integrated touch screen, including: a transparent substrate having two faces; a flat panel display matrix forming an electroluminescent display located on one face of the substrate for emitting light through the substrate; touch sensitive elements of a touch screen located on the other face of the substrate; and a single flex-cable containing a plurality of conductors electrically connected to both the flat panel display matrix and the touch sensitive elements for providing external electrical connection to the display.

### FIELD OF THE INVENTION

This invention relates generally to color flat panel displays and, more particularly, to an electroluminescent flat panel display with integral touch sensitive elements.

### BACKGROUND OF THE INVENTION

Modem electronic devices provide an increasing amount of functionality with a decreasing size. By continually integrating more and more capabilities within electronic devices, costs are reduced and reliability increased. Touch screens are frequently used in combination with conventional soft displays such as cathode ray tubes (CRTs), liquid crystal displays (LCDs), plasma displays and electroluminescent displays. The touch screens are manufactured as separate devices and mechanically mated to the viewing surfaces of the displays.

FIG. 1 shows a prior art touch screen 10. A touch screen 10 includes a transparent substrate 12. This substrate 12 is typically glass, but other materials, such as plastic, may be used. Various additional layers of materials comprising touch sensitive elements 14 of the touch screen 10 are formed on top of the substrate 12. The touch sensitive elements 14 include transducers and circuitry that is necessary to detect a touch by an object, in a manner that can be used to compute the location of such a touch. A cable 16 is attached to the circuitry so that various signals may be brought onto or off of the touch screen 10. The other end of the cable 16 is connected to an external controller 18.

FIG. 2 shows a cross section view of a typical prior art electroluminescent display such as an organic light emitting diode (OLED) flat panel display 20 of the type shown in U.S. Pat. No. 5,937,232, issued Aug. 10, 1999 to Tang. The OLED display includes a substrate 22 that provides mechanical support for the display device, a transistor switching matrix layer 24 comprised of a two dimensional array of thin film transistors 26, a light emission layer 28 containing materials forming organic light emitting diodes, and a cable 30 for connecting circuitry within the flat panel display to external controller 32. The substrate 22 is typically glass, but other materials, such as plastic, may be used. The transistor switching matrix layer 24 is formed and patterned using typical semiconductor manufacturing processes. Together, transistor switching matrix layer 24 and the light emission layer 28 comprise a flat panel display matrix 29.

Conventionally, when a touch screen is used with a flat panel display, the touch screen is simply placed over the flat panel display, and the two are held together by a mechanical mounting means such as a frame. FIG. 3 shows such a prior art arrangement with a touch screen mounted on an OLED flat panel display. After the touch screen and the OLED display are assembled, the two substrates 12 and 22 are placed together in a frame 34, often separated by a mechanical separator 36. The resulting assembly contains two cables 16 and 30 that connect the touch screen and the flat panel display to external controllers.

U.S. Ser. No. 09/826,194, filed Apr. 4, 2001 by Siwinski et al. proposes a device in which an organic electroluminescent flat panel display is integrated with a touch screen, sharing a common substrate. FIG. 4 shows this structure. A display with touch screen 38 contains a single substrate 40 with two faces. An image display containing a flat panel display matrix 29 and a cable 30 is manufactured on one face. Touch sensitive elements 14 and cable 16 are manufactured on the opposite face. This invention has advantages over existing touch screen and flat panel display combinations with decreased cost, no integration steps, decreased weight and thickness, and improved optical quality.

However, the invention of Kilmer et al. still contains two cables 16 and 30. This duplication adds to system cost, since two cables are needed to interface one display module to external circuitry, and therefore two connectors to receive these cables are needed as well. Additionally, the presence of two cables, rather than one, requires an additional assembly step during system integration, since the two cables must be connected to two different connectors. This makes system integration unnecessarily complex, since room must be made for two separate cables and therefore connectors in which these cables must plug.

There remains a need for an improved touch screen electroluminescent display system that removes redundant materials, decreases cost, and simplifies system integration tasks.

### SUMMARY OF THE INVENTION

The need is met according to the present invention by providing an electroluminescent display with integrated touch screen, including: a transparent substrate having two faces; a flat panel display matrix forming an electroluminescent display located on one face of the substrate for emitting light through the substrate; touch sensitive elements of a touch screen located on the other face of the substrate; and a single flex-cable containing a plurality of conductors electrically connected to both the light emitting elements and the touch sensitive elements for providing external electrical connection to the display.

### ADVANTAGES

The present invention has the advantage that it reduces complexity of the display, thereby reducing manufacturing costs and improving reliability of the display.

### BRIEF DESCRIPTION OF THE DRAWINGS

FIG. 1 is a schematic diagram showing the basic structure of a prior art touch screen;

FIG. 2 is a schematic diagram showing the structure of a prior art organic electroluminescent display;

FIG. 3 is a schematic diagram showing the combination of a touch screen with a flat panel electroluminescent display mounted using a bracket, as would be accomplished in the prior art;

FIG. 4 is a schematic diagram showing the combination of a touch screen with a flat panel electroluminescent display manufactured on a single substrate, and provided with separate external connections for the display and the touch screen;

FIG. 5 is a schematic diagram showing the basic structure of an electroluminescent display with a touch screen and a single flex-cable according to the present invention;

FIGS. 6a and 6b are schematic diagrams showing an embodiment of the present invention with a split flex-cable;

FIGS. 7a and 7b are schematic diagrams showing an embodiment of the present invention with an unsplit flex-cable and metal contacts connecting the two sides of the substrate; and

FIGS. 8a and 8b are schematic diagrams showing an embodiment of the present invention with a single metallized cable connecting to contacts on two sides of the substrate.

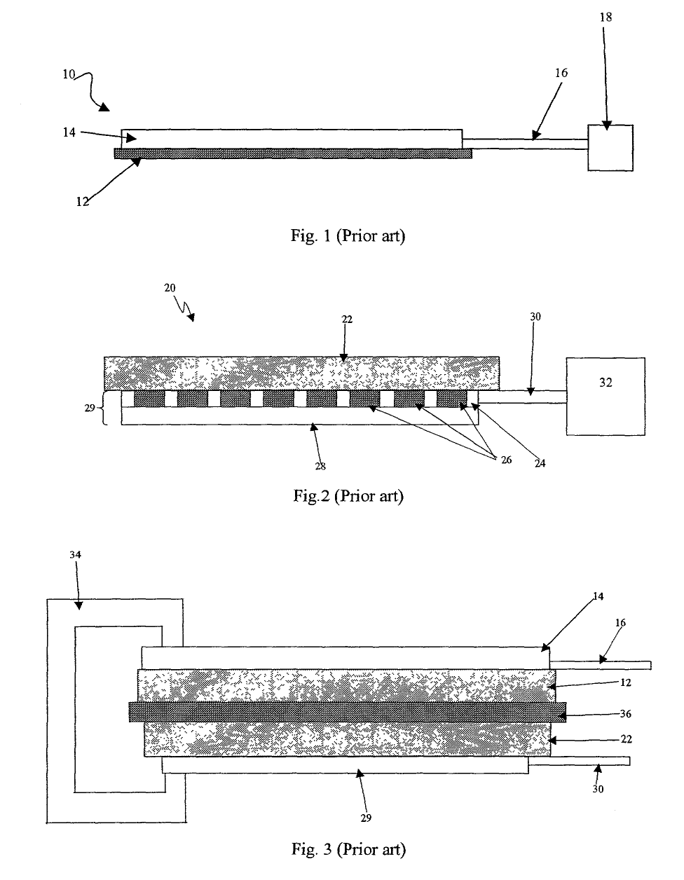

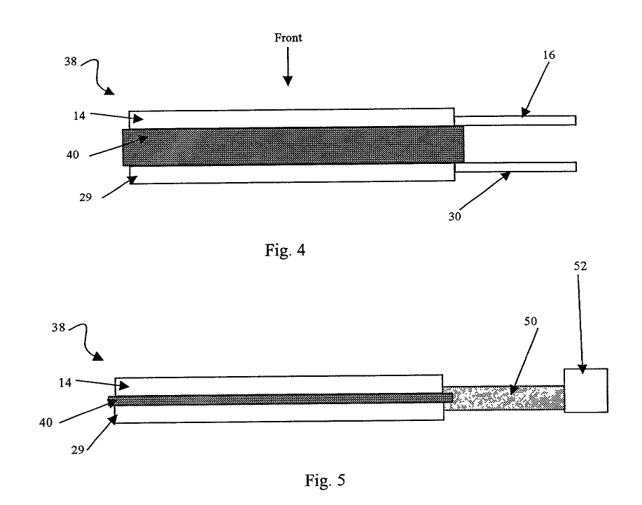

### DETAILED DESCRIPTION OF THE INVENTION

Referring to FIG. 5, an electroluminescent display generally designated 38 according to the present invention includes a single substrate 40 having a flat panel display matrix 29 of an electroluminescent display formed on one face of the substrate for emitting light through the substrate, touch sensitive elements 14 of a touch screen formed on the other face of the substrate 40, and a single flex-cable 50 used for connecting the electroluminescent display 38 with external electronics 52. As used herein, the term flex-cable refers to a flat, flexible laminated cable, for example of the type sold by the Parlex Corporation, Methuen, Mass.. The substrate 40 is made of a transparent material, such as glass or hard plastic, and is thick enough to provide mechanical support for the flat panel display matrix 29 and the touch sensitive elements 14.

The flex-cable 50 contains conductors that allow image data, display control signals, bias voltages, and touch screen signals to pass between external electronics 52 and the electroluminescent display 38. External electronics 52 contain circuitry to control the touch sensitive elements 14 and the flat panel display matrix 29, and is typically some combination of external controllers 18 and 32. The circuitry can physically be either in one integrated circuit, or in a multiplicity of packages. The signals carried by conductors in flex-cable 50 are routed on a circuit board to the appropriate circuitry. The number of conductors in the flex-cable 50 of this embodiment is equal to the number of conductors needed in the cable 16 plus the number of conductors needed in the cable 30.

This improved display eliminates the need for a second cable, a second connector for mating with this second cable, and therefore eliminates one assembly step during system integration, as well as the cost of a second cable and connector. This reduces system cost, manufacturing cost, and system integration complexity.

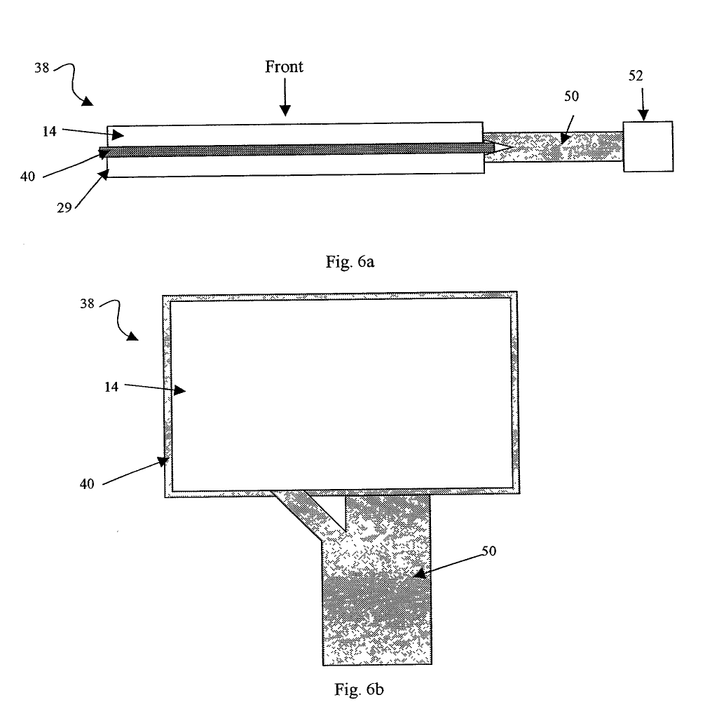

FIG. 6a shows a side view of an embodiment of the present invention where the flex-cable 50 is bifurcated near the end that is attached to metallic pads within the flat panel display matrix 29 and within the touch sensitive elements 14. FIG. 6b shows a front view of this embodiment. Here, all conductors within the flex-cable 50 that connect to the touch sensitive elements 14 are within the portion of the flex-cable that is attached to the touch sensitive elements 14. All conductors within the flex-cable 50 that connect the flat panel display matrix 29 are within the portion that is attached to the flat panel display matrix 29.

Metallic pads are formed on each side of the substrate 40 via a photolithography process in conjunction with chemical vapor deposition (CVD), electroplating, ebeam, ion-beam, or x-ray processing. The metallic pad formation occurs simultaneous to the manufacturing of the touch sensitive elements 14 and the flat panel display matrix 29; the metallic pads are a part of these layers. The flex-cable 50 is attached to these metallic pads via a conventional bonding process, such as wire bonding or crimp bonding. Contacts of the cable adhere to both semiconducting and insulating layers, are highly conductive, and are capable of handling high current densities while still maintaining their electrical integrity. The contacts are typically made of gold, silver, or aluminum, but any other highly conductive materials could be used. This embodiment has the advantage of simplicity of manufacturing of the image display.

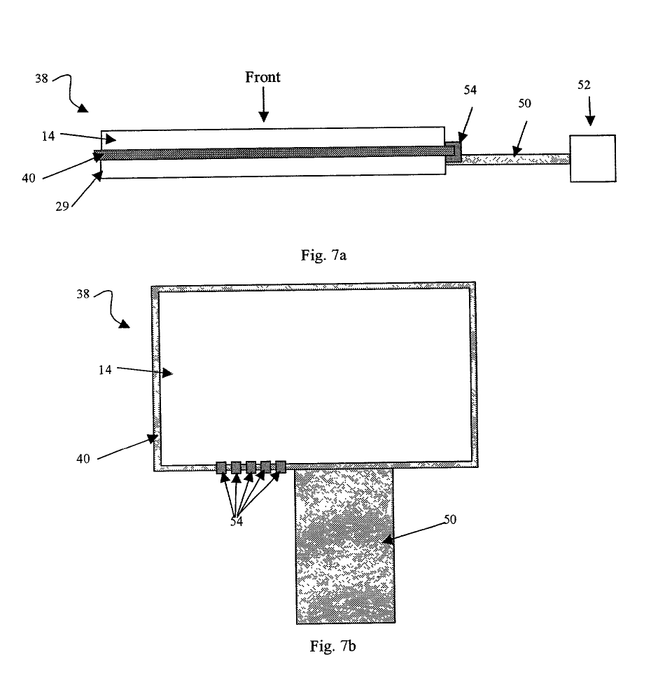

FIG. 7a shows an edge view of an embodiment of the present invention where flex-cable 50 is not bifurcated, and is attached to only one face of the substrate 40. FIG. 7b shows a front view of this embodiment. The flex-cable 50 is attached to the flat panel display matrix 29, rather than to the touch sensitive elements, since more conductors are typically needed for the display. The touch sensitive elements are connected to the appropriate conductors in the flex-cable 50 via conductors 54 such as metal connectors that are attached to the sides of the substrate 40. The metal connectors 54 are vacuum deposited, electrochemically attached, screen printed, or glued along the edges of the substrate 40 and bonded to the two faces of the substrate 40. Metallic pads are formed within the flat panel display matrix 29 for attaching the flex-cable to the electroluminescent display 38.

This arrangement increases the robustness of the resulting electroluminescent display by allowing the attachment of the flex-cable 50 to the electroluminescent display 38 on just one face of the substrate 40, thereby reducing the strain on flex-cable 50, which may be subjected to various forces during system integration. This embodiment has the advantage of simplicity in cable bonding, since no bifurcation of the flex-cable is required, and all conductors are attached to the same side of the substrate 40.

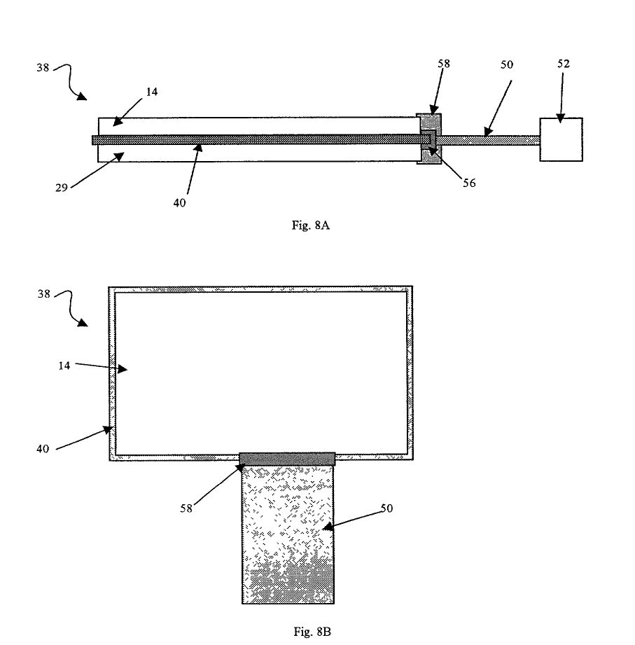

FIG. 8a shows an edge view of an embodiment of the present invention where flex-cable 50 is not bifurcated, or connected to one face of the substrate 40 but is connected directly to a metallization layer 56 deposited on a side of the substrate 40. FIG. 8b shows a front view of this embodiment. The metallization layer 56 is vacuum deposited, electrochemically attached, screen printed, or glued along the edges of the substrate 40 and bonded to the two faces of the substrate 40. Connections to both the flat panel display matrix 29 and the touch sensitive elements 14 are made via metal connectors formed within the metallization layer 56. The flex-cable 50 is attached to the metallization layer 56 via a cable bonding method such as wire bonding or crimp bonding, and held in place by cable clip 58. This embodiment has the advantage of increased robustness of the resulting electroluminescent display by allowing the attachment of the flex-cable 50 to both the flat panel display matrix 29 and the touch sensitive elements 14 in only one location, reducing the strain on flex-cable 50, which may be subjected to various forces during system integration.

The invention has been described in detail with particular reference to certain preferred embodiments thereof, but it will be understood that variations and modifications can be effected within the spirit and scope of the invention.

PARTS LIST
10 touch screen
12 substrate
14 touch sensitive elements
16 cable
18 external controller
20 flat panel display
22 substrate
24 transistor switching matrix layer
26 thin film transistor
28 light emission layer
29 flat panel display matrix
30 cable
32 external controller
34 frame
36 mechanical separator
38 display with touch screen
40 substrate
50 flex-cable
52 external electronics
54 metal connector
56 metallization layer
58 cable clip

What is claimed is:

1. An electroluminescent display with integrated touch screen, comprising:
a) a transparent substrate having two faces;
b) a flat panel display matrix forming an electroluminescent display located on one face of the substrate for emitting light through the substrate;
c) touch sensitive elements of a touch screen located on the other face of the substrate; and
d) a single flex-cable containing a plurality of conductors electrically connected to both the flat panel display matrix and the touch sensitive elements for providing external electrical connection to the display.

2. The display of claim 1, wherein the flat panel display matrix contains OLEDs.

3. The display of claim 1, wherein the flex-cable is bifurcated at the end attached to the display, such that the one part of the bifurcation is attached to the flat panel display matrix and the other part is attached to the touch sensitive elements.

4. The display of claim 1, wherein the flex-cable is directly connected to only one face of the substrate, and conductors are located on one or more edges of the substrate to connect signals carried by the flex-cable to circuitry on the other face of the substrate.

5. The display of claim 4, wherein the flex-cable is attached to the face containing the flat panel display matrix.

6. The display of claim 1, wherein the flex-cable is connected to a clip attached to an edge of the substrate, and the clip having metal contacts to connect conductors within the cable to the flat panel display matrix and the touch sensitive elements of the display.
